(19) United States
(12) Patent Application Publication
(10) Pub. No.: US 2016/0076625 A1
(43) Pub. Date: Mar. 17, 2016

(54) TRANSMISSION FOR SELF-PROPELLED ROLLING VEHICLE AND SELF-PROPELLED VEHICLE EQUIPPED WITH SUCH A TRANSMISSION

(71) Applicant: FRANCE REDUCTEURS, les-Herbiers (FR)

(72) Inventor: Fabien Guiroult, Saint Hilaire Le Vouhis (FR)

(21) Appl. No.: 14/784,690

(22) PCT Filed: Apr. 22, 2014
(86) PCT No.: PCT/FR2014/050962

§ 371 Date: Oct. 15, 2015

(30) Foreign Application Priority Data
Apr. 22, 2013 (FR) 1353634

(51) Int. Cl. F16H 3/08; F16D 27/115; F16D 13/38; F16H 9/12; F16H 61/02

(52) U.S. Cl. CPC F16H 3/08; F16H 9/12; F16H 61/0204; F16D 13/38; F16D 27/115

(57) ABSTRACT

The invention relates to a transmission (6) for a self-propelled wheeled vehicle (1) of the type comprising at least one rotary inlet shaft (8), an outlet shaft (9) suitable for driving at least one wheel (3) of the vehicle in rotation, a casing (7) that houses said shafts (8, 9) at least partially, and motion transmission means (10) for transmitting the motion of the inlet shaft (8) to the outlet shaft (9). Said transmission is characterized in that the motion transmission means (10) comprise at least one electromagnetic clutch (11).

The present invention relates to a transmission for a self-propelled wheeled vehicle, the transmission being of the type positionable between the primary drive shaft and the wheels of said vehicle, and the present invention also relates to a self-propelled vehicle, such as a sit-on-top lawn mower, equipped with such a transmission.

The invention relates more particularly to a transmission for a self-propelled wheeled vehicle of the type comprising at least one rotary inlet shaft, an outlet shaft suitable for driving at least one wheel of the vehicle in rotation, a casing that houses said shafts at least partially, and motion transmission means for transmitting the motion of the inlet shaft to the outlet shaft.

Transmissions of the above-mentioned type are already known to persons skilled in the art. Those transmissions are of the positive-clutch or friction types. When such transmissions include direction reversal means, the motion transmission and direction reversal means include a direction reversal moving positive clutch suitable for coming into engagement with one or the other of two counter-rotating positive clutch elements. One of those elements can be referred to as the “forwards” positive clutch element, while the other can be referred to as the “reverse” positive clutch element. Those forwards and reverse positive clutch elements engage continuously with one of the shafts, e.g. the inlet shaft of the transmission, and are selectively couplable to/decouplable from the other shaft, e.g. the outlet shaft of the transmission, via said moving positive clutch. Such a transmission suffers from two major drawbacks, namely firstly it needs a large control force to be exerted for reversing the direction by moving the moving positive clutch in one or the other of the directions, and secondly it requires a complex clutch device of the progressive type to be provided upstream from the positive clutch device in order to guarantee direction reversal when the device is in the declutched state, with the risk otherwise being that the transmission might break. In friction clutches, the control force is also large.

An object of the present invention is to propose a transmission of design that makes it possible to reduce the control force that needs to be generated for causing motion to be transmitted and optionally for causing direction to be reversed.

Another object of the present invention is to propose a transmission of design that makes it possible to reverse the rotation direction of the outlet shaft quickly at any time, without any risk of breakage.

To these ends, the invention provides a transmission for a self-propelled wheeled vehicle of the type comprising at least one rotary inlet shaft, an outlet shaft suitable for driving at least one wheel of the vehicle in rotation, a casing that houses said shafts at least partially, and motion transmission means for transmitting the motion of the inlet shaft to the outlet shaft, said transmission being characterized in that the motion transmission means comprise at least one electromagnetic clutch.

Omitting the positive clutch device and replacing it with at least one electromagnetic clutch offers the above-mentioned advantages.

Preferably, the transmission includes direction reversal means for reversing the direction of rotation of the outlet shaft with a view to driving the vehicle forwards or backwards.

Preferably, in a preferred embodiment of the invention, the direction reversal means are at least partially common to the motion transmission means and they comprise at least one direction selector member formed by the electromagnetic clutch, or by at least one of the electromagnetic clutches of the motion transmission means.

Preferably, the motion transmission means comprise at least two electromagnetic clutches.

Preferably, the or each electromagnetic clutch carried by a “clutch-carrying” shaft comprises two clutch elements, a “first” one of which clutch elements is mounted to be free to rotate on the shaft that carries it, and the “second” other one of which clutch elements is constrained to rotate with the shaft that carries it, said first and second clutch elements also being mounted on said shaft that carries them to be movable axially between a “clutched” position in which they are close together, and a “declutched” position in which they are spaced apart.

Said first and second clutch elements of each clutch are mounted, on said shaft that carries them, to be movable axially between a “clutched” position in which they are close together, and a “declutched” position in which they are spaced apart by said first and second clutch elements moving relative to each other.

The first and second clutch elements going from one position to the other can thus take place by one of the elements moving axially, or by both of the elements moving axially.

In a first embodiment, the clutch-carrying shaft of one of the electromagnetic clutches is common to the clutch-carrying shaft of the other or of at least one other electromagnetic clutch.

In a second embodiment, the clutch-carrying shaft of one of the electromagnetic clutches is distinct from the clutch-carrying shaft of the other or of at least one other electromagnetic clutch.

Independently of the embodiment, the or each clutch-carrying shaft is preferably disposed substantially parallel to the outlet shaft. However, a solution in which the or each clutch-carrying shaft is preferably disposed substantially orthogonally to the outlet shaft is also possible.

Preferably, the first element of the or each clutch is in the form of a bell threaded over the shaft carrying said clutch, in a manner coaxial about said shaft, and the second element of the or each clutch is a clutch disk that is centrally hollow so as to be suitable for being threaded over the corresponding clutch-carrying shaft, said first and second clutch elements of the or each clutch being mounted to move in the direction in which they come closer together under the action of a coil housed, preferably, at least partially inside the bell of said clutch, when said coil is in the powered state.

Preferably, the motion transmission and motion reversal means comprise first motion transmission means between the inlet rotary shaft and the first clutch elements and for driving the first clutch elements in rotation, and second motion transmission means between each clutch-carrying shaft or each first clutch element and the outlet shaft so as to make it possible, when one of said clutches is in the clutched state, for the motion of the corresponding clutch-carrying shaft to be transmitted to the outlet shaft.

The motion transmission and direction reversal means thus have two transmission paths for transmitting motion between the rotary inlet member and the outlet shaft, each transmission path being equipped with a respective electromagnetic clutch.

Thus, for each transmission path, the motion transmission and clutch means comprise first motion transmission means for transmitting motion from the inlet rotary shaft to the first clutch element of the clutch of said path, and second motion transmission means for transmitting motion from the clutch-carrying shaft or the first clutch element of said path to the outlet shaft. At least some of these first and second transmission means may be common to both of the paths.

Also preferably, the first motion transmission means are endless loop and/or gear transmission means configured to drive the first clutch elements in rotation in counter-rotating manner.

In particular, in an embodiment, with the rotary inlet member preferably being a worm screw or a shaft equipped with a gear, the first transmission means comprise a toothed wheel and two gearing parts mounted with said toothed wheel to be constrained to rotate with one another and to be free to rotate on the outlet shaft, said toothed wheel engaging with the rotary inlet member, and one of the gearing parts, such as a gear, continuously engaging with a gearing part carried by one of the clutch-carrying shafts in such a manner as to be free to rotate on said shaft and constrained to rotate with the first clutch element of the clutch carried by said shaft, the other gearing part being connected via an endless loop transmission, and preferably via a chain transmission, to a gearing part carried by the other clutch-carrying shaft in a manner such as to be free to rotate on said shaft and constrained to rotate with the first clutch element of the clutch carried by said shaft.

Preferably, the second motion transmission means between each clutch-carrying shaft or each first clutch element, and the outlet shaft are endless loop and/or gear transmission means that engage continuously with the outlet shaft.

In particular, in an embodiment, the second motion transmission means between each clutch-carrying shaft and the outlet shaft include an “outlet” gearing part carried by, and mounted to rotate with, the outlet shaft, and two gearing parts with which said outlet gearing part engages continuously, one of these two gearing parts being mounted on one of the clutch-carrying shafts to be constrained to rotate with it, and the other gearing part being mounted on the other clutch-carrying shaft to be constrained to rotate with it.

Preferably, the transmission includes power supply means for feeding electricity to the clutch(es).

Preferably, when the transmission includes at least two electromagnetic clutches, said clutches are configured to take up at least three states:

a first state in which said clutches are in the clutched position;

a second state in which said clutches are in the declutched position; and

a third state in which one of the clutches is in the declutched position and the other is in the clutched position.

When the motion transmission means include at least two electromagnetic clutches, the power supply means for feeding electricity to the clutches comprise a first electric circuit suitable for connecting one of the electromagnetic clutches to an electricity source, such as the battery of the vehicle, a second electric circuit suitable for connecting the other of the electromagnetic clutches to an electricity source, and open/close control means for causing the first and second circuits to open or to close.

In a first embodiment of the invention, the electromagnetic clutches are selectively activatable, and the open/close control means for causing the first and second circuit to open or to close comprise main control means that act as a function of the state of operation of the vehicle, and that are suitable for taking up a closure position in which they close the first and second circuits when the vehicle is in the switched-on state, and auxiliary control means mounted to move between a position in which they close the first circuit and open the second circuit, and a position in which they close the second circuit and open the first circuit.

One of the electromagnetic clutches is thus powered by default when the vehicle is in the switched-on state. When the inlet shaft is a worm screw, said clutch may, in the clutched position, be used as an element of an engine brake system.

In a second embodiment of the invention, the electromagnetic clutches are selectively activatable, and the open/close control means for causing the first and second circuit to open or to close comprise main control means that act as a function of the state of operation of the vehicle, and that are suitable for taking up a closure position in which they close the first and second circuits when the vehicle is in the switched-on state, and auxiliary control means mounted to move between a position in which they close the first circuit and open the second circuit, and a position in which they close the first and second circuits.

Generally, the auxiliary open/close control means for causing the first and second circuits to open or to close comprise at least one switch and mechanical means, such as a cam for driving the switch(es) into position.

Preferably, the transmission includes a variable speed drive for varying the speed of rotation of the rotary inlet shaft, said variable speed drive being a belt variable speed drive.

When the vehicle is of the type including a primary drive shaft, the variable speed drive is interposable between the primary drive shaft and the inlet shaft.

Generally, this variable speed drive includes at least one belt endless loop transmission between a driven pulley carried by the inlet rotary shaft of said transmission casing and a driving pulley having flanges between which the spacing is variable and mounted on a driving shaft that is preferably carried by said transmission casing, and to which the motion of the primary drive shaft is suitable for being transmitted.

In a first embodiment, the driving shaft and the drive shaft are made in one piece. In particular, the driving shaft is then not carried by the casing.

In a variant, the driving shaft carries a second pulley having non-variable flanges and connectable via an endless loop transmission member of the belt or chain type to a pulley carried by the primary drive shaft for transmitting the motion of the primary drive shaft to the driving shaft. The shaft carrying the driving pulley also has control assistance means for assisting in causing the flanges of the driving pulley to come closer together, which driving pulley is said to be actuated “automatically”, said assistance means comprising a cam formed of two aligned plates having ramps for sliding contact, one of the plates being constrained to rotate with the controlled moving flange of the driving pulley, the other plate being constrained to rotate with the shaft carrying the driving pulley, said plates tending to move apart in the direction in which the flanges of the driving pulley move closer together under the effect of the transmitted torque. The driving pulley may also be equipped with return means for urging the flanges of the pulley back into the position in which they are spaced apart from each other. The control means for causing the flanges of the driving pulley to move closer together comprise at least one member formed by the mechanical drive means for driving the switch(es) into position, so that the control for clutching the driving pulley, for varying the speed associated with the flanges moving closer together, and for clutching the electromagnetic clutch(es) is common.

Preferably, the driving pulley, which has its variable-spacing flanges suitable for being driven in the direction in which they come closer together by a spacing-reduction control device, is a declutchable pulley, and includes declutching means formed of at least one idler member, such as bearing or a ring disposed between said flanges, said idler member having an outside peripheral surface that is mounted to be free to rotate relative to the shaft carrying the driving pulley, and around which the belt winds at least partially in the declutched position corresponding to the position in which the flanges are spaced apart in such a manner as to prevent any transmission of motion between pulley-carrying shafts. This moving flange of the driving pulley comes to overlap the idler member while the flanges of said pulley are moving closer together so as to enable the belt to wind inside the groove formed by the flanges and so as to allow the variable speed drive to go over to the clutched position, the flanges of the driving pulley continuing to move closer together allowing the speed to be varied at will. The other flange of the driving pulley is a flange that is mounted on the shaft carrying the pulley to be constrained to rotate with said shaft, and that is movable axially on said shaft while the flanges of said pulley are being caused to move closer together until it reaches a thrusting contact position against the second pulley or a part constrained to rotate with said second pulley so as to enable the motion of the second pulley to be transmitted to said flanges.

The invention further provides a self-propelled wheeled vehicle of the type including at least one primary drive shaft, at least one wheel, and at least one transmission that is positionable between the primary drive shaft and the at least one wheel, said self-propelled wheeled vehicle being characterized in that the transmission is a transmission of the above-mentioned type.

Preferably, the vehicle has two driven wheels, two transmissions, each of which is associated with a respective driven wheel, and forwards/reverse control means for each transmission in such a manner as to make it possible, if necessary, in parallel to a wheel being driven backwards, to drive the other wheel forwards.

The invention can be well understood on reading the following description of embodiments given with reference to the accompanying drawings, in which:

FIG. 1 is a perspective view of a transmission of the invention, seen from the outlet shaft side;

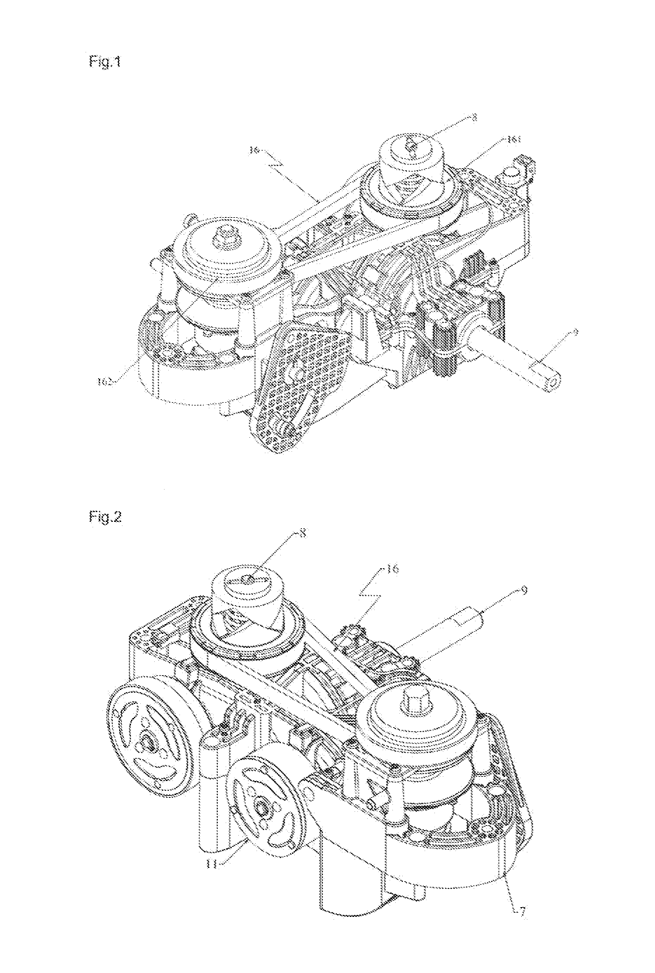

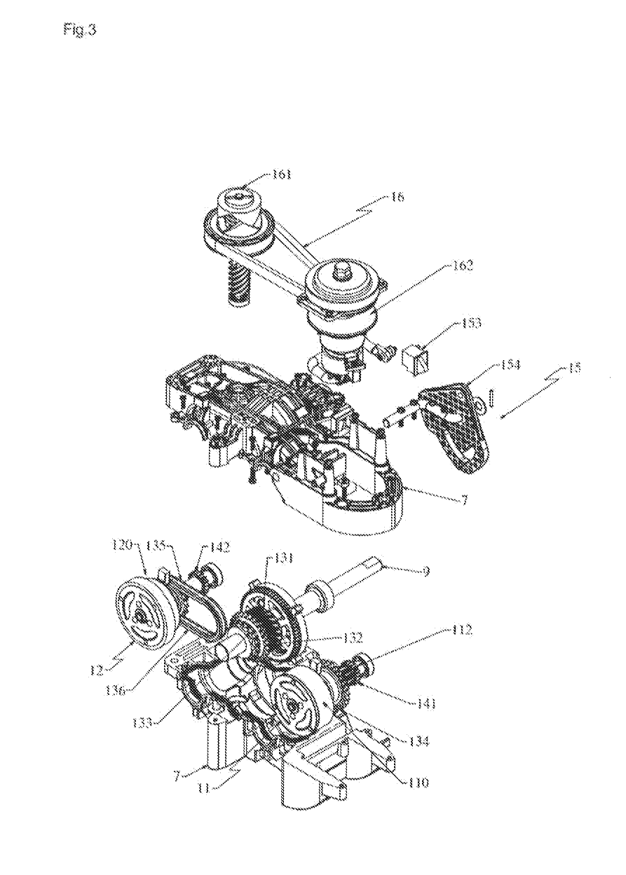

FIG. 2 is a perspective view of a transmission of the invention, seen from the clutch side;

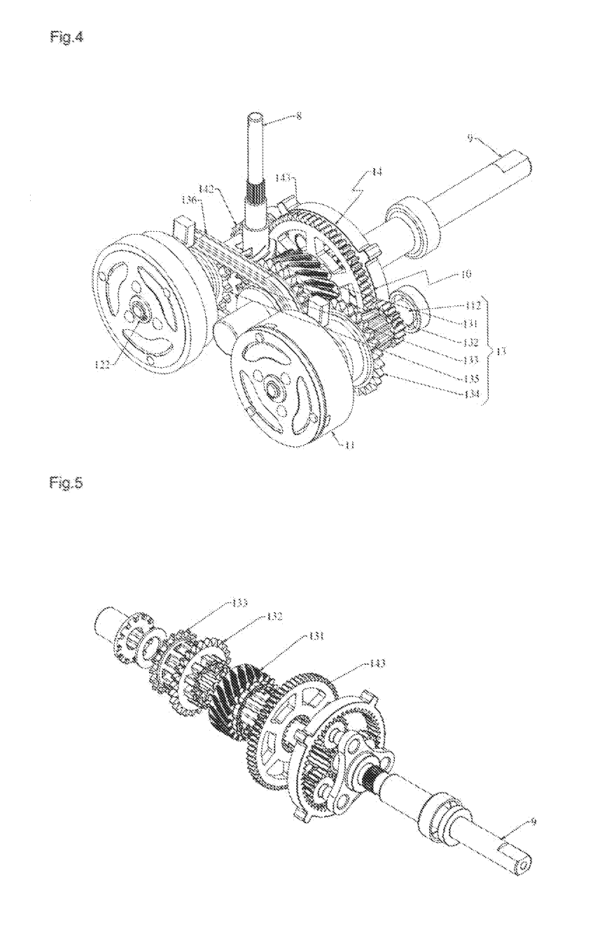

FIG. 3 is an exploded view of the elements of the transmission;

FIG. 4 is a perspective view of the first and second transmission means and of the clutches between the inlet shaft and the outlet shaft;

FIG. 5 is an exploded view of the elements of the outlet shaft;

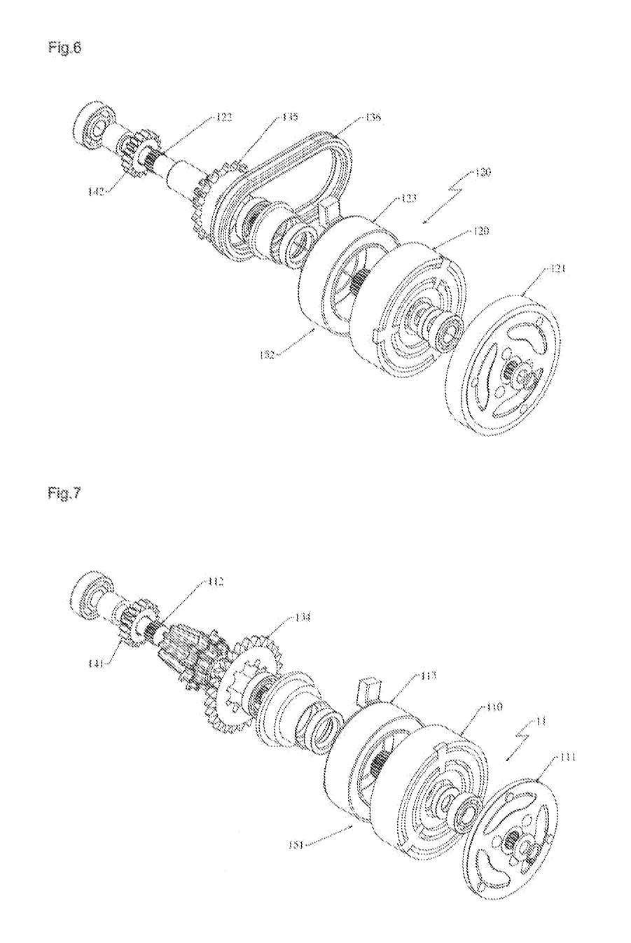

FIG. 6 is an exploded view of the elements of one of the clutch-carrying shafts;

FIG. 7 is an exploded view of the elements of the other of the clutch-carrying shafts;

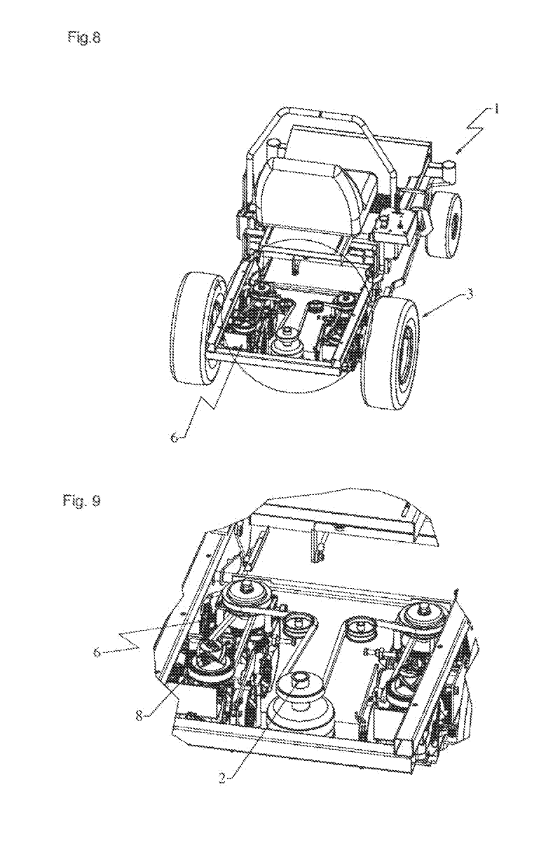

FIG. 8 is a perspective view of a vehicle equipped with a transmission of the invention;

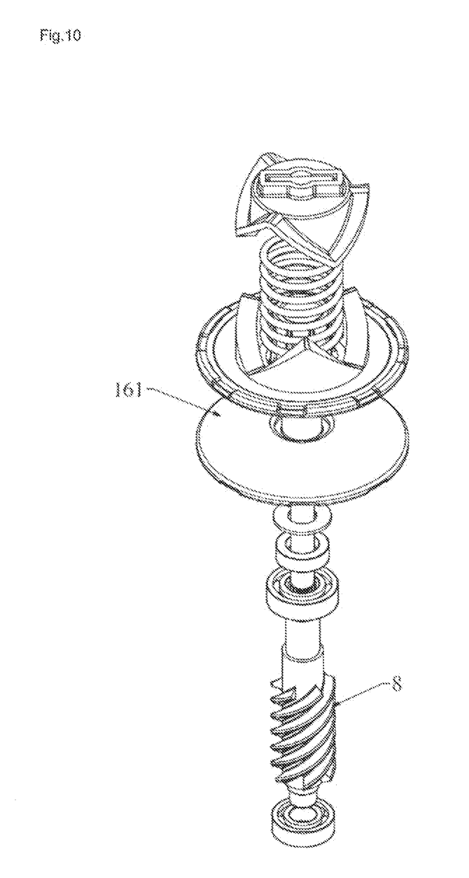

FIG. 9 is a view of detail A of FIG. 8;

FIG. 10 is an exploded view of the driven pulley placed on the inlet shaft;

FIG. 11 is an exploded view of the driving pulley placed on the driving shaft of the variable speed drive;

FIG. 12 is a section view of the driving shaft/driving pulley assembly of FIG. 11;

FIG. 13 shows a transmission casing with an inlet shaft equipped with a motor having two rotation directions and a single electromagnetic clutch;

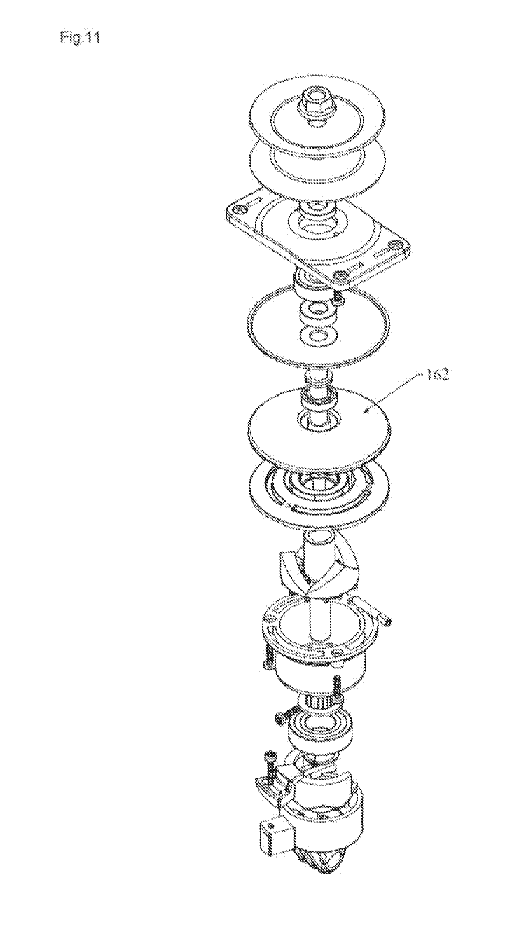

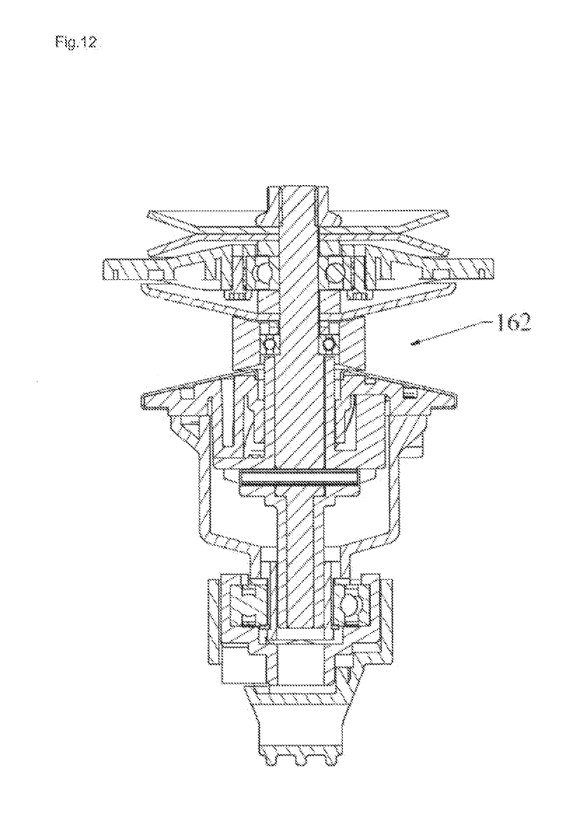

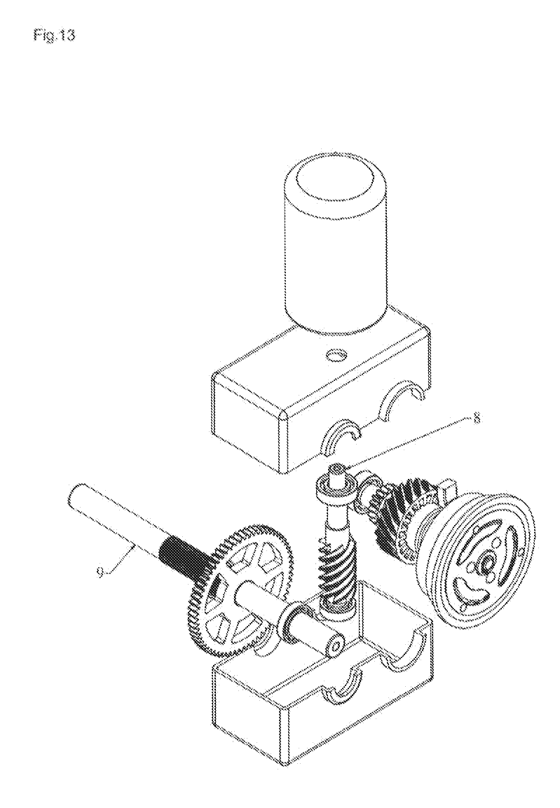

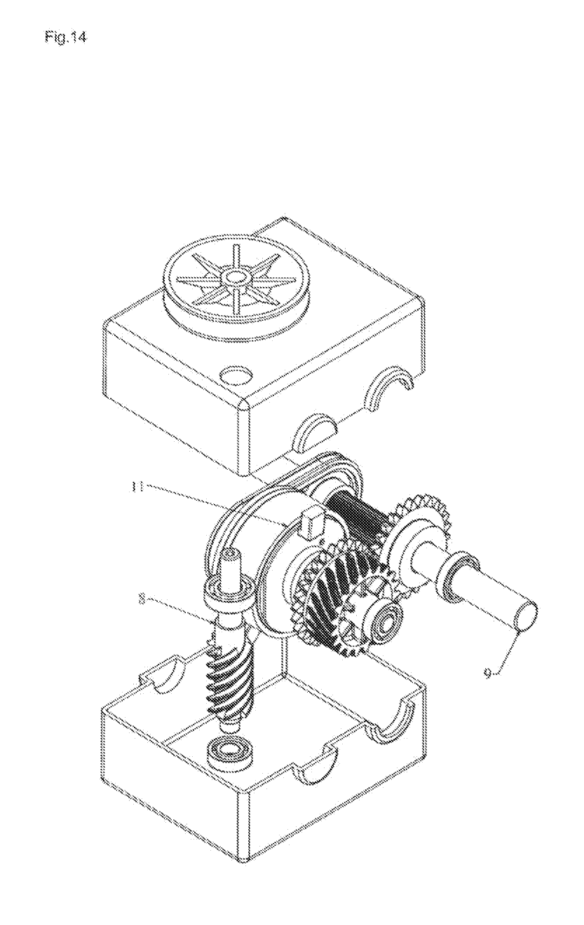

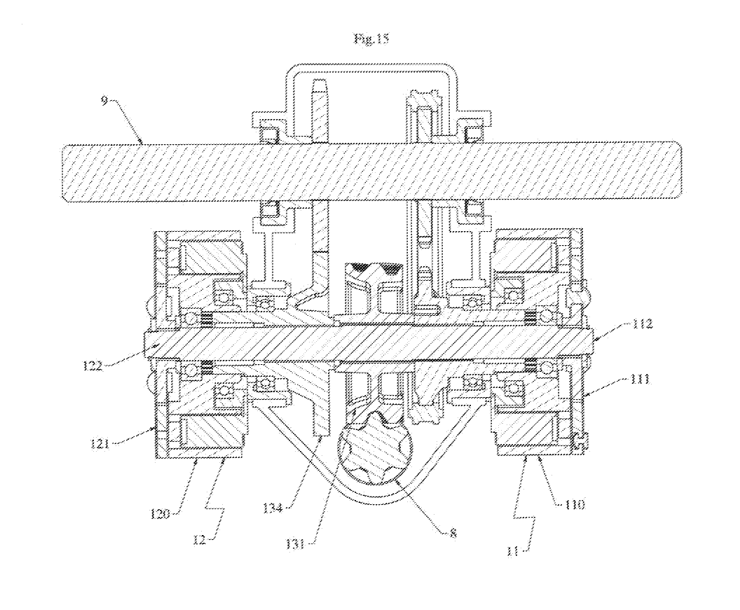

FIG. 14 is a diagrammatic view of a transmission casing with a single electromagnetic clutch that, in the clutched position, drives the outlet shaft in the forwards direction and, in the declutched position, makes it possible to drive the outlet shaft in the reverse direction; and

FIG. 15 is a section view of another embodiment of a transmission of the invention.

In the embodiment shown in FIGS. 1 to 12, the transmission 6 of the invention is designed to be installed on a self-propelled vehicle having a primary drive shaft 2 and wheels 3. In the example shown, the vehicle 1 has two driven wheels 3, which, in this example, are the rear wheels, and two non-driven wheels formed by the front wheels of the vehicle. This vehicle has one transmission 6 per driven wheel and one forwards/reverse control member per driven wheel. These control members are shown at 4 and 5, and they are in the form of pivotally mounted levers.

The driven wheels thus operate independently from each other and, for example, one of them can be caused to rotate in the forwards direction while the other is caused to rotate in the reverse direction, thereby making it possible to procure a vehicle that is extremely maneuverable, and capable of turning on the spot, i.e. of having a zero turn radius.

The primary drive shaft 2 of the vehicle is coupled via a belt endless loop transmission to a first transmission 6 associated with one of the driven wheels of the vehicle and to a second transmission 6 associated with the other driven wheel of the vehicle. Naturally, in equivalent manner, the invention applies to a vehicle having a single transmission, on which both of the wheels are driven wheels and are coupled to a common outlet shaft that can be driven forwards or backwards by said transmission.

In the example shown in the figures, the transmissions are identical from one wheel to the other. Therefore, only one transmission is described. The transmission 6 includes a casing 7, which, in this example is made up of two half-casings, assembled together via a join plane. This housing 7 is equipped with a rotary inlet shaft 8 represented by a worm screw that penetrates partially into said casing via an opening in the casing. This casing is also provided with an outlet shaft 9 that projects partially from the casing and that, in the example shown, extends orthogonally to the worm screw. Said outlet shaft 9 is designed to be coupled to a wheel 3 of the vehicle. Said casing is also provided with motion transmission and direction reversal means 10 between the worm screw 8 and the outlet shaft 9. Said motion transmission and direction reversal means 10 include two electromagnetic clutches 11, 12. Each clutch is carried by a “clutch-carrying” shaft that, in the examples, is placed partially inside the casing and parallel to the outlet shaft 9. Thus, the electromagnetic clutch 11 is carried by the shaft 112 and the electromagnetic clutch 12 is carried by the shaft 122. Each of said clutches includes a first clutch element that is in the form of a bell threaded over the shaft that carries said clutch, said bell being mounted to be free to rotate on said shaft. Each of said clutches further includes a second clutch element formed by a clutch disk that is centrally hollow so that it can be threaded over the clutch-carrying shaft, said second clutch element being mounted to be constrained to rotate with the clutch-carrying shaft.

Finally, each of said clutches includes a stationary coil that, in this example, is partially received inside the bell. Thus, the clutch 11, carried by the shaft 112, includes a bell 110, a clutch disk 111, and a coil 113. Similarly, the clutch 12, carried by the shaft 122, includes a bell 120, a clutch disk 121, and a coil 123. Each coil is powered via an electric circuit that is connectable, for example, to the battery of the vehicle. The electric circuit for powering the coil 113 is referred to as the “first” electric circuit in this example, and is shown at 151 in FIG. 7, and the electric circuit for powering the coil 123 is referred to as the “second” electric circuit, and is shown at 152 in FIG. 6. The first and second electric circuits are equipped with open/close control means that are suitable for being actuated by the driver of the vehicle when said driver acts on the forwards/reverse controls 4, 5 of the vehicle. The transmission includes power supply means 15 for feeding electricity to the clutches 11, 12, which means comprise a first electric circuit 151 suitable for connecting one of the electromagnetic clutches (11) to an electricity source, such as the battery of the vehicle, a second electric circuit 152 suitable for connecting the other of the electromagnetic clutches (12) to an electricity source, and open/close control means 153, 154 for causing the first and second circuits 151, 152 to open or to close.

In the examples shown, these selective power supply means include a switch 153 and a rotary cam 154 for driving the switch 153 so as to move it by thrusting contact. This cam, which is driven in rotation on the basis of the forwards/reverse manual controls of the vehicle, is suitable for enabling the switch 153 to go from a position in which it opens the first circuit 151 and closes the second circuit 152 to a position in which it closes the first circuit 151 and opens the second circuit 152. It is assumed that the first circuit 151, which powers the clutch 11, is closed when the forwards position is selected by the driver, and that the second circuit 152, which powers the clutch 12, is closed when the reverse position is selected. By default, i.e. when the forwards/reverse control members 4, 15 of the vehicle are in the neutral position, and, when the vehicle is in the switched-on state, one of the circuits (preferably the forwards circuit) is closed. The first and second electric circuits are equipped with main control means, the only purpose of which is to close the electric circuit between the electricity source, such as a battery, and the auxiliary control means, when the vehicle is in the switched-on state, i.e. when the ignition of the vehicle is switched on, so as to avoid the electricity source being discharged during the stages when the vehicle is switched off (the engine of the vehicle is switched off). Said main means may be formed merely by an on/off switch that, in the powered state, closes the common portion of the first and second electric circuits that extends between the electricity source and the auxiliary control means.

A circuit being closed by the auxiliary control means causes the corresponding clutch to go from the declutched state to the clutched state, and causes the motion of the rotary inlet shaft 8 to be transmitted via the corresponding clutch-carrying shaft to the outlet shaft 9. A clutch goes over from the declutched state to the clutched state when the coil of said clutch is powered, by the moving disk moving along the clutch-carrying shaft in the direction in which the disk moves closer to the bell.

In order to enable such motion transmission to take place, the motion transmission and direction reversal means 10 include first motion transmission means 13 between the inlet rotary shaft 8 and the first clutch elements 110, 120 for driving said first clutch elements 110, 120 in rotation, and second motion transmission means 14 between each clutch-carrying shaft 112, 122 and the outlet shaft 9. The first motion transmission means 13 include a toothed wheel 131 engaging with the worm screw 8 that forms the rotary inlet shaft. The worm screw 8 is placed tangentially relative to the toothed wheel 131, which is itself mounted to be free to rotate on the outlet shaft 9. This toothed wheel, which is coaxial about the outlet shaft 9, is mounted to be constrained to rotate with two gearing parts 132 and 133 also carried by the outlet shaft 9, one of which parts is formed by a spur gear shown at 132 in the figures, and the other of which is formed by a chain sprocket gear shown at 133 in the figures. The spur gear 132 comes to engage by meshing with a gearing part 134, which, in this example, is a spur gear. This spur gear 134 is threaded over the clutch-carrying shaft 112 and is mounted to be free to rotate on said shaft but to be constrained to rotate with the bell 110 forming the first clutch element of the clutch carried by said shaft. Thus, when the worm screw transmits its motion so the toothed wheel, said toothed wheel drives the gear 132 in rotation, which gear comes to engage with the gear 134, which, itself, drives the clutch bell 110 in rotation, since it is constrained to rotate with said bell. If the clutch 11 is in the declutched position, no motion is transmitted to the clutch-carrying shaft. If the clutch 11 is in the clutched position, the rotary motion of the bell 110 is transmitted via the clutch disk 111 to the clutch-carrying shaft 112. The second gearing part 133, namely the chain sprocket gear 133, with which the toothed wheel 131 is mounted to be constrained to rotate, is itself connected, via a chain 136, to a chain sprocket gear 135 forming the gearing part carried by the clutch-carrying shaft 122 of the clutch 12. Said clutch part 135 is mounted to be constrained to rotate with the bell 120 forming the first clutch element of the clutch 12. Thus, when the worm screw transmits its motion to the toothed wheel, said toothed wheel drives the chain sprocket gear 133 in rotation, which gear transmits its motion to the chain sprocket gear 135, which, itself, drives the clutch bell 120 in rotation, since it is constrained to rotate with said bell. If the clutch 12 is in the declutched position, no motion is transmitted to the clutch-carrying shaft 122. If the clutch 12 is in the clutched position, the rotary motion of the bell 120 is transmitted via the clutch disk 121 to the clutch-carrying shaft 122. It should be noted that the bells 110 and 120 are, merely due to the action of the first transmission means, driven in rotation in opposite directions. The second transmission means 14 include an “outlet” gearing part 143 carried by and mounted to be constrained to rotate with the outlet shaft 9 via an epicyclic gear train. In this example, this gearing part is formed by a spur gear. Said second motion transmission means 14 further include gearing parts 141, 142 with which said outlet gearing part 143 engages continuously. These two gearing parts, also formed by spur gears, one of which (shown at 141 in the figures) is mounted to be constrained to rotate with the clutch-carrying shaft 112, and the other of which (shown at 142 in the figures) is mounted to be constrained to rotate with the clutch-carrying shaft 122. When it is the clutch 11 that is in the clutched position, the outlet shaft 9, to which the motion of the clutch-carrying shaft 112 is transmitted, turns in a direction opposite from the direction in which said shaft 112 turns. When it is the clutch 12 that is in the clutched position, the outlet shaft 9, to which the motion of the shaft 122 is transmitted, turns in a direction opposite from the direction in which said shaft 122 turns. Since the clutch-carrying shafts turn in opposite directions, the outlet shaft 9 turns in one direction or the other depending on which clutch is in the clutched position.

For transmitting the motion of the primary drive shaft 2 of the vehicle to the rotary inlet shaft 8, namely the worm screw, the vehicle includes a variable speed drive 16 including at least a first belt endless loop transmission that connects the pulley carried by the drive shaft 2 to a “second” pulley carried by a driving shaft and having non-variable flanges. This driving shaft carries a second pulley that is referred to as the “driving” pulley 162 and that, itself, transmits its motion via a belt to a driven pulley 161 carried by the inlet rotary shaft 3. These pulleys 161 and 162 have flanges between which the spacing is variable so as to enable speed to be varied. Such speed variation is controlled by the driver of the vehicle by using the same control means as those that enable the driver so reverse the direction of travel from forwards to reverse and vice versa. In other words, the vehicle includes forwards/reverse control means, and control means for controlling the variable speed drive, said control means being at least partially common means. As mentioned above, said control means are generally pivotally mounted levers that are mounted to move between a forwards position and a reverse position by going through a neutral position.

Such a vehicle operates as follows. The engine of the vehicle is running. One of the clutches, e.g. the clutch 11 corresponding to the vehicle moving in the forwards direction, is powered by default. If the driver actuates the control means in the forwards direction, said driver causes clutching to take place at the belt transmission disposed between the primary drive shaft and the worm screw, and then causes the vehicle to travel forwards at a speed that is a function of the spacing between the flanges of the driving pulley of said endless loop transmission. If the driver operates said control means in the reverse direction, the switch is actuated and it opens the power supply circuit of clutch 11 and closes the power supply circuit of clutch 12, which becomes the powered clutch, and the variable speed drive is brought back to the declutched or neutral position. The driver continuing to move the control means causes clutching to take place at the belt transmission disposed between the primary drive shaft and the worm screw, and then causes the vehicle to reverse at a speed that is a function of the spacing between the flanges of said transmission.

FIG. 13 shows another embodiment of the invention. In this embodiment, the inlet shaft 3 of the casing is equipped with a motor having two rotation directions so as to enable the inlet shaft to be driven in a direction corresponding to forwards or in a direction corresponding to reverse.

The electromagnetic clutch is disposed between the inlet shaft and the outlet shaft and, in the clutched position, it participates in transmitting motion from the inlet shaft to the outlet shaft. In the simplest version, the casing includes a worm screw forming the inlet shaft 8. This worm screw comes to engage with a toothed wheel carried by a shaft that carries the electromagnetic clutch and a gear that comes to engage by meshing with a gear carried by the outlet shaft.

FIG. 14 shows another embodiment of the invention. The transmission casing includes a single electromagnetic clutch that, in the clutched position, drives the outlet shaft 9 in the forwards direction and, in the declutched position, makes it possible so drive the outlet shaft in the reverse direction. In the example shown, the inlet shaft of the casing that is formed by a worm screw 8 comes so engage with a toothed wheel that is mounted to be constrained to rotate with a shaft carrying the clutch disk of the electromagnetic clutch, said clutch disk being interposed between the coil of the clutch and a gear mounted to be free to rotate on the shaft carrying the clutch disk. A return spring urges the clutch disk to bear against said gear so as to transmit the motion in rotation of the clutch disk to said gear, which is itself suitable for transmitting its motion, via a chain transmission, to the outlet shaft in a first direction. The coil of the clutch, in the powered state, urges the clutch disk back into the position in which it bears against the bell that houses the coil, which bell is mounted to be constrained to rotate with a gear that meshes with a gear carried by the outlet shaft for driving the outlet shaft in rotation in an opposite direction.

FIG. 15 shows another embodiment of a transmission having two electromagnetic clutches. In a manner similar to the manner described above, this transmission includes an inlet shaft 8 formed by a worm screw that engages with a toothed wheel 131 that is mounted to be constrained to rotate with a shaft that carries the two electromagnetic clutches 11 and 12. The two clutches are thus carried by a single, common shaft, unlike what is described above. As above, each of these clutches includes a first clutch element that is in the form of a bell threaded over the shaft that carries said clutch, said bell being mounted to be free to rotate on said shaft. Each of said clutches further includes a second clutch element formed by a clutch disk that is centrally hollow so that it can be threaded over the clutch-carrying shaft, said second clutch element being mounted to be constrained to rotate with the clutch-carrying shaft.

These clutches operate similarly to what is described above. The motion transmission between the inlet rotary shaft 8 and the first elements 110, 120, namely the clutch bells, takes place as follows. The toothed wheel is mounted to be constrained to rotate with the clutch disks, which are carried and mounted to be constrained to rotate with the same shaft as the shaft that carries the toothed wheel. When one of the clutches is brought into the clutched position by moving the disk of said clutch closer to the bell of said clutch, the rotary motion of the disk is transmitted to the bell. Said bell engages with the outlet shaft via gear means or endless loop means, and transmits its rotary motion to the outlet shaft, optionally with the rotation direction being reversed at the coupling means. If both of the clutches are in the declutched position, no motion is transmitted to the outlet shaft.

In the example shown, with the right clutch in the clutched state, the right bell drives the outlet shaft 9 in the same rotation direction as the bell, via a chain transmission. When the left clutch is in the clutched state, the left clutch drives the outlet shaft 9 is a rotation direction opposite from the rotation direction of the bell, via a cog gear.

The embodiment of the invention in which said electromagnetic clutches are successively clutchable is not shown.

1. A transmission for a self-propelled wheeled vehicle, the vehicle having at least one rotary inlet shaft, an outlet shaft suitable for driving at least one wheel of the vehicle in rotation, a casing that houses said shafts at least partially, and motion transmission means for transmitting the motion of the inlet shaft to the outlet shaft, said transmission comprising:
at least one electromagnetic clutch.

2. A transmission according to claim 1, wherein said transmission includes direction reversal means for reversing the direction of rotation of the outlet shaft with a view to driving the vehicle forwards or backwards.

3. A transmission according to claim 2, wherein the direction reversal means are disposed on the inlet shaft and are formed by a motor having two rotation directions.

4. A transmission according to claim 2, wherein the direction reversal means are at least partially common to the motion transmission means and they have at least one direction selector member formed by the electromagnetic clutch, or by at least one of the electromagnetic clutches of the motion transmission means.

5. A transmission according to claim 1, wherein the motion transmission means has at least two electromagnetic clutches.

6. A transmission according to claim 1, wherein the or each electromagnetic clutch carried by a “clutch-carrying” shaft has two clutch elements, a “first” one of which clutch elements is mounted to be free to rotate on the shaft that carries it, and the “second” other one of which clutch elements is constrained to rotate with the shaft that carries it, said first and second clutch elements of each clutch also being mounted on said shaft that carries them to be movable axially between a “clutched” position in which they are close together, and a “declutched” position in which they are spaced apart.

7. A transmission according to claim 6, wherein the first element of the or each clutch is in the form of a bell threaded over the shaft carrying said clutch, in a manner coaxial about said shaft, and in that the second element of the or each clutch is a clutch disk that is centrally hollow so as to be suitable for being threaded over the corresponding clutch-carrying shaft, said first and second clutch elements of the or each clutch being mounted to move in the direction in which they come closer together under the action of a coil housed, preferably, at least partially inside the bell of said clutch, when said coil is in the powered state.

8. A transmission according to claim 5, taken in combination with claim 2, wherein the motion transmission and motion reversal means comprise first motion transmission means between the inlet rotary shaft and the first clutch elements and for driving the first clutch elements in rotation, and second motion transmission means between each clutch-carrying shaft or each first clutch element and the outlet shaft so as to make it possible, when one of said clutches is in the clutched state, for the motion of the corresponding clutch-carrying shaft to be transmitted to the outlet shaft.

9. A transmission according to claim 8, wherein the first motion transmission means are endless loop and/or gear transmission means configured to drive the first clutch elements in rotation in counter-rotating manner.

10. A transmission according to claim 8, wherein the second motion transmission means between each clutch-carrying shaft or each first clutch element and the outlet shaft are endless loop and/or gear transmission means that engage continuously with the outlet shaft.

11. A transmission according to claim 1, characterized wherein said transmission includes a variable speed drive for varying the speed of rotation of the rotary inlet shaft, said variable speed drive being a belt variable speed drive.

12. A transmission according to claim 11 for a vehicle of the type including a primary drive shaft, wherein the belt variable speed drive is interposable between the primary drive shaft and the inlet shaft, said variable speed drive including at least one belt endless loop transmission between a driven pulley carried by the inlet rotary shaft of said transmission casing, and a driving pulley having flanges between which the spacing is variable, and mounted on a driving shaft preferably carried by said transmission casing, and to which the motion of the primary drive shaft is suitable for being transmitted.

13. A transmission according to claim 1, wherein said transmission includes power supply means for feeding electricity to the clutch(es).

14. A transmission according to claim 13, taken in combination with claim 5, wherein the power supply means for feeding electricity to the clutches has a first electric circuit suitable for connecting one of the electromagnetic clutches to an electricity source, such as the battery of the vehicle, a second electric circuit suitable for connecting the other of the electromagnetic clutches to an electricity source, and open/close control means for causing the first and second circuits to open or to close.

15. A transmission according to claim 14, wherein the electromagnetic clutches are selectively activatable, and in that the open/close control means for causing the first and second circuits to open or to close comprise main control means that act as a function of the state of operation of the vehicle, and that are suitable for taking up a closure position in which they close the first and second circuits when the vehicle is in the switched-on state, and auxiliary control means mounted to move between a position in which they close the first circuit and open the second circuit, and a position in which they close the second circuit and open the first circuit.

16. A transmission according to claim 14, wherein the electromagnetic clutches are selectively activatable, and in that the open/close control means for causing the first and second circuits to open or to close comprise main control means that act as a function of the state of operation of the vehicle, and that are suitable for taking up a closure position in which they close the first and second circuits when the vehicle is in the switched-on state, and auxiliary control means mounted to move between a position in which they close the first circuit and open the second circuit, and a position in which they close the first and second circuits.

17. A transmission according to claim 15 or claim 16, wherein the auxiliary open/close control means for causing the first and second circuits to open or to close comprise at least one switch and mechanical means, such as a cam for driving the switch(es) into position.

18. A self-propelled wheeled vehicle of the type including at least one primary drive shaft, at least one wheel, and at least one transmission that is positionable between the primary drive shaft and the at least one wheel, said self-propelled wheeled vehicle being wherein the transmission is a transmission according to claim 1.
